(19) United States
(12) Patent Application Publication
(10) Pub. No.: US 2007/0076620 A1
(43) Pub. Date: Apr. 5, 2007

(54) Apparatus and method for management information base table for storing and accessing medium sensing time histogram measurement results

(76) Inventors: Zhun Zhong, Croton-On-Hudson, NY (US); Stefan Mangold, Ossining, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/575,519

(22) PCT Filed: Oct. 12, 2004
(86) PCT No.: PCT/IB04/52072

§ 371 Date: Apr. 13, 2006

Related U.S. Application Data
(60) Provisional application No. 60/510,995, filed on Oct. 14, 2003.

(51) Int. Cl. H04L 12/26

(52) U.S. Cl. 370/252; 370/328

(57) ABSTRACT

A Medium Sensing Time Histogram Table structure is provided for inclusion in a Management Information Base (MIB) for storing and accessing Medium Sensing Time Histogram measurement results, such as Medium Sensing Time Histogram Measurement Reports. A predetermined number of entries may be provided in the Medium Sensing Time Histogram Report Table for this purpose. An apparatus and method is provided for a wireless device to enter and access entries in the Medium Sensing Time Histogram Report Table. The method and apparatus is intended for use in the IEEE 802.11k standard as well as any WLAN requiring measurement of the medium.

The present invention relates to wireless local area networks (WLANs). More particularly the present invention relates to wireless device management of WLANS by assessing radio resources using Medium Sensing Time Histogram Reports. Most particularly, the present invention relates to an apparatus and method for using Management Information Base (MIB) Tables of a radio device to store a history of received and locally generated Medium Sensing Time Histogram Reports. The method and apparatus of the present invention is intended for use in the IEEE 802.11k standard as well as any WLAN requiring measurement of the medium.

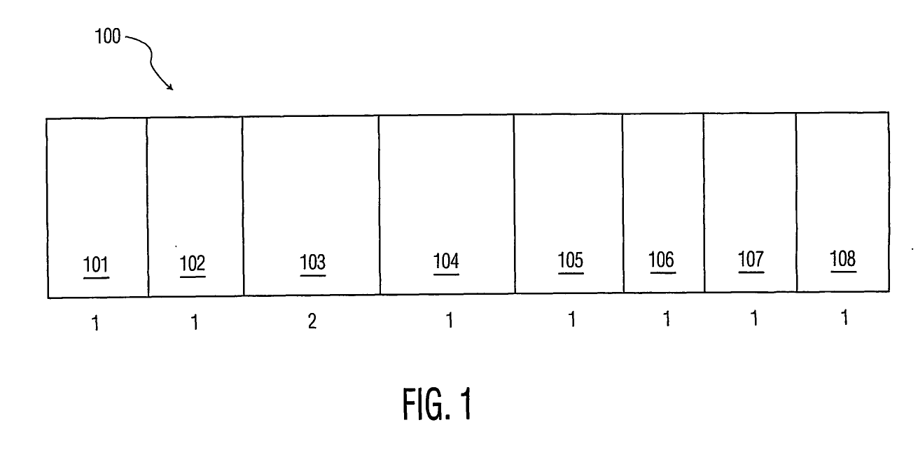

Today's radio environment in which WLANs typically operate is a largely unregulated scarce resource. A radio device such as a WLAN station (STA) must be able to measure and assess the radio environment and take corresponding actions. A radio device such as a wireless station (STA) can both sense the medium and request other radio devices (other STAs) to report on their own sensing or measurement of the medium. One type of measurement that can be requested is a Medium Sensing Time Histogram. A format of a Measurement Request field 100 corresponding to a Medium Sensing Time Histogram Request is shown in FIG. 1. The fields are described as follows:
a. The Channel Number 101 indicates the channel number for which the measurement request applies.

b. The Channel Band 1012 indicates the frequency band, taken from Table 1 in which the Channel Number applies.

TABLE 1
Channel Band 102 definitions for radio measurement requests

| Name | Channel Band |
|---|---|
| 2.4 GHz Band | 0 |
| 5 GHz Band | 1 |
| Reserved | 2-255 |

c. The Measurement Duration 103 can be set equal to the duration of the requested measurement, expressed in timer units (TUs).

d. The Medium Sensing Measurement Subtype 104 indicates the subtype of Medium Sensing Measurements to make. The available subtypes of Medium Sensing Measurement are defined in Table 2.

TABLE 2
Medium Sensing Measurement Subtype 104 definition

| Medium Sensing | Medium Sensing Measurement |
|---|---|
| Measurement Subtype | Time Histogram Name |
| 0 | RPI Time Histogram |
| 1 | CCA Idle Time Histogram |
| 2 | CCA Busy Time Histogram |
| 3 | NAV Busy Time Histogram |
| 4-255 | Reserved |

e. The RPI Threshold 105 identifies a received power level threshold according to Table 4, as seen at the antenna connector. The RPI Threshold is used to determine if a Medium Sensing Event occurs, while collecting information for the RPI Time Histogram.
f. The Bin Offset 106 indicates the position of the first bin, expressed in microseconds.
g. The Bin Interval 107 indicates the time interval during which Medium Sensing Events are counted to be in this bin, expressed in slot times. Medium Sensing Events are defined in Table 3.
h. The Number of Bins 108 indicates the total number of time intervals that are covered by the time histogram.

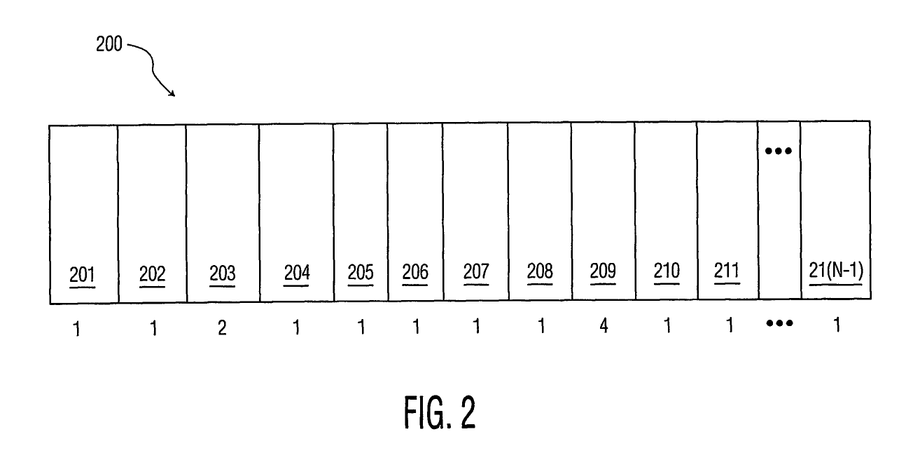

A radio device, e.g., a STA, reports measurements using a Measurement Report element. The format of a Measurement Report field 200 of a Medium Sensing Time Histogram Report is shown in FIG. 2. The subfields are defined as follows:
a. The Channel Number 201 indicates the channel number to which the Medium Sensing Time Histogram Report applies.
b. The Channel Band 202 indicates the measured frequency band, taken from Table 2, in which the Channel Number applies.
c. Measurement Duration 203 is set equal to the duration over which the Medium Sensing Time Histogram Report was measured, expressed in TUs.

d. The Medium Sensing Measurement Subtype 204 indicates the subtype of Medium Sensing Time Histogram Report, as defined in Table 3.

TABLE 3
Medium Sensing Measurement Subtype definition

| Medium Sensing | |
|---|---|
| Measurement Subtype | Medium Sensing Measurement Name |
| 0 | RPI Time Histogram |
| 1 | CCA Idle Time Histogram |
| 2 | CCA Busy Time Histogram |
| 3 | NAV Busy Time Histogram |
| 4-255 | Reserved |

e. The RPI Threshold 205 identifies a received power level threshold according to Table 4, as seen at the antenna connector. The RPI Threshold is used to determine if a Medium Sensing Event occurs, while collecting information for the RPI Time Histogram.

TABLE 4
RPI Threshold Definitions for an RPI Time Histogram

| RPI | Power Observed at Antenna (dBm) |
|---|---|
| 0 | −87 |
| 1 | −82 |
| 2 | −77 |
| 3 | −72 |
| 4 | −67 |
| 5 | −62 |
| 6 | −57 |
| 7-255 | reserved |

The Medium Sensing Time Histogram Report contains in each of N Bins the densities in each of the N time intervals as measured in the specified channel over the measurement duration.
f. The Bin Offset 206 indicates the position of the first bin, expressed in microseconds.
g. The Bin Interval 207 indicates the time interval during which Medium Sensing Events are counted to be in this bin, expressed in slot times. Medium Sensing Events are defined in Table 5.
h. The Number of Bins 208 indicates the total number of time intervals that are covered by the time histogram.

i. The Total Number of Medium Sensing Events 209 indicates how many events have been counted during the measurement.

TABLE 5
Definition of Medium Sensing Event

| Medium Sensing | Medium Sensing Measurement | Medium Sensing Event for |
|---|---|---|
| Measurement Subtype | Name | Bin i |
| 0 | RPI Time Histogram | RPI changes from value higher |
| | | than threshold to value lower |
| | | than RPI threshold within the |
| | | interval (i0 + [i * Δi . . . (i + 1) * Δi]) |
| 1 | CCA Idle Time Histogram | CCA state changes from idle to |
| | | busy within the interval |
| | | (i0 + [i * Δi . . . (i + 1) * Δi]) |
| 2 | CCA Busy Time Histogram | CCA state changes from busy |
| | | to idle within the interval |
| | | (i0 + [i * Δi . . . (i + 1) * Δi]) |
| 3 | NAV Busy Time Histogram | NAV duration within the |
| | | interval (i0 + [i * Δi . . . (i + 1) * Δi]) |
| | | detected |
| 4-255 | reserved | reserved |

j. Bin i density 21i, with 0≦i<N, e.g., 210, 211, 212, 213, . . . , is computed by the STA monitoring the contiguous duration of the monitored state and incrementing count, Bᵢ, corresponding to Bin i and if a Medium Sensing Event occurs during the measurement at time t with
   i0+(i*Δi)<t≦i0+((i+1)*Δi) for any i<N−1,
   i0+(i*Δi)≦t for i=N−1,
then the number of events per Bin i is increased by one. During the Medium Sensing Measurement, a histogram is generated that represents the probability distribution of Medium Sensing Events in time.

Ability to predict future radio environment characteristics is based on past characteristics so there should be a history of such reports, both locally generated by a radio device and received by the device. Currently, there is no way to create a history of Medium Sensing Time Histogram Reports.

The IEEE 802.11 standard specifies request and report means, including the formats of FIGS. 1 and 2, but does not currently provide any mechanism for retaining a history of these measurements over time either by a measuring STA or a STA receiving one or more measurement reports. However, IEEE 802.1k contemplates implementing storing these reports by a STA in its MIB Table. Accordingly, the present invention provides a mechanism for storing these reports and locally obtained measurements by a STA in its MIB Table that can be implemented within its existing processing logic under the control of its SME.

Thus, there is a need for a way to capture and retain a history of Medium Sensing Time Histogram Measurement Reports taken over time.

The present invention is directed to an apparatus and method for a wireless radio device to capture a history of Medium Sensing Time Histogram Reports. The present invention defines a format for storing locally generated and received Medium Sensing Time Histogram Reports over time as a sequence of entries in a MIB Table of a STA.

Another aspect of the present invention provides an apparatus for capturing locally generated medium sensing results and received medium sensing time histogram reports and storing them as at least one entry in the MIB Table of the radio device whose MIB Table format has been modified according to the present invention. The apparatus includes a transceiver coupled to a measurement management module for receiving locally generated medium sensing reports and histogram reports generated by other devices and storing them locally as at least one entry in the modified MIB Table of the radio device.

The foregoing and other features and advantages of the invention will be apparent from the following, more detailed description of preferred embodiments as illustrated in the accompanying drawings in which reference characters refer to the same parts throughout various views.

FIG. 1 illustrates a Medium Sensing Time Histogram Request format;

FIG. 2 illustrates a format of a Medium Sensing Time Histogram Report according to an embodiment of the present invention;

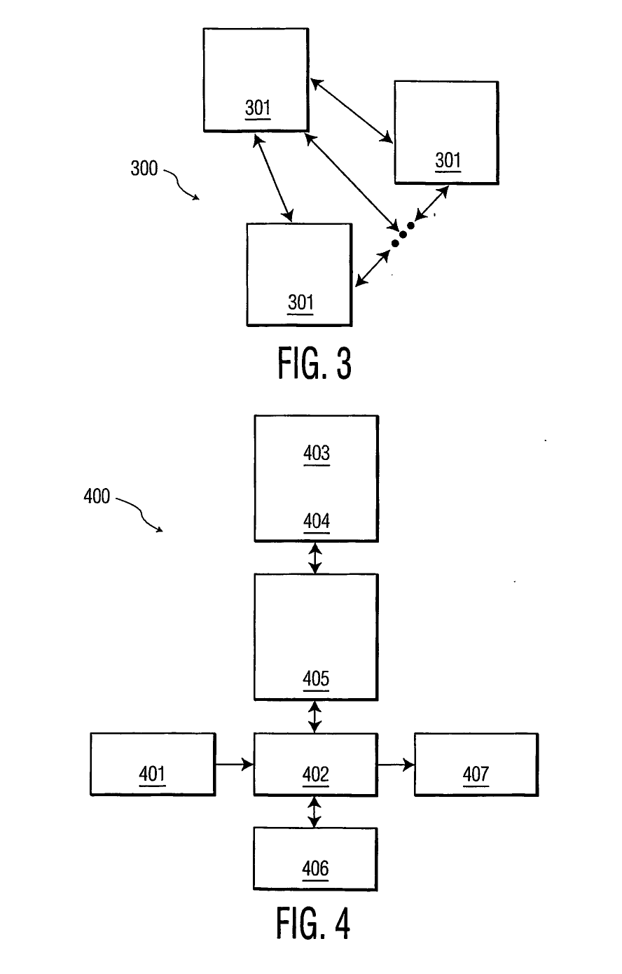

FIG. 3 is a simplified block diagram illustrating the architecture of a wireless communication system whereto embodiments of the present invention are to be applied;

FIG. 4. illustrates a simplified block diagram of a wireless device of the communication system of FIG. 3 modified to perform at least one of obtain locally and request from another network device a Medium Sensing Time Histogram Report and store it locally, according to an embodiment of the present invention;

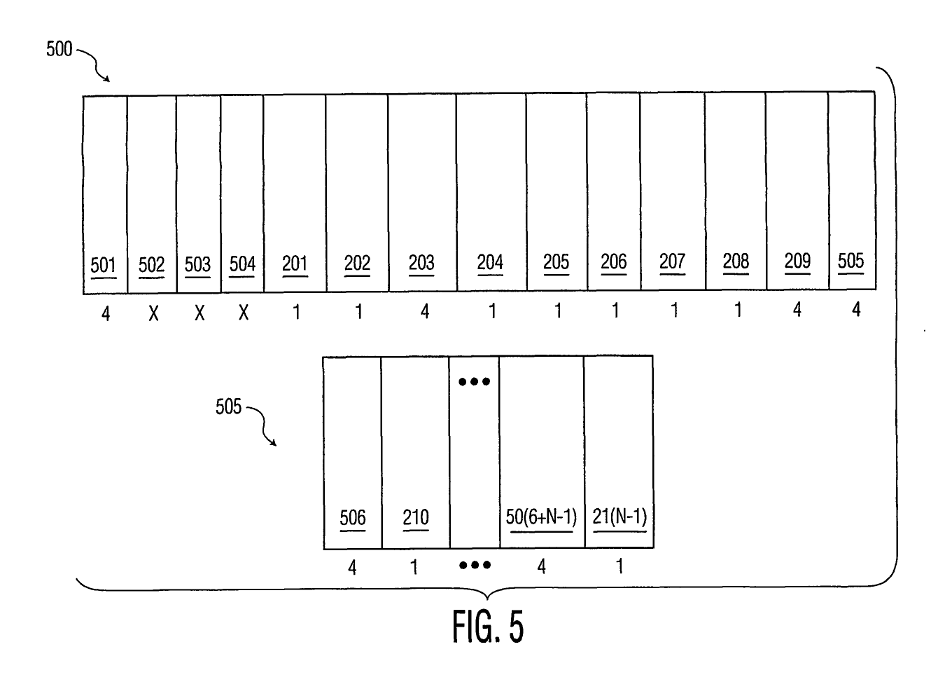

FIG. 5 illustrates a format of a MIB Table entry for a Medium Sensing Time Histogram Report Table according to an embodiment of the present invention;

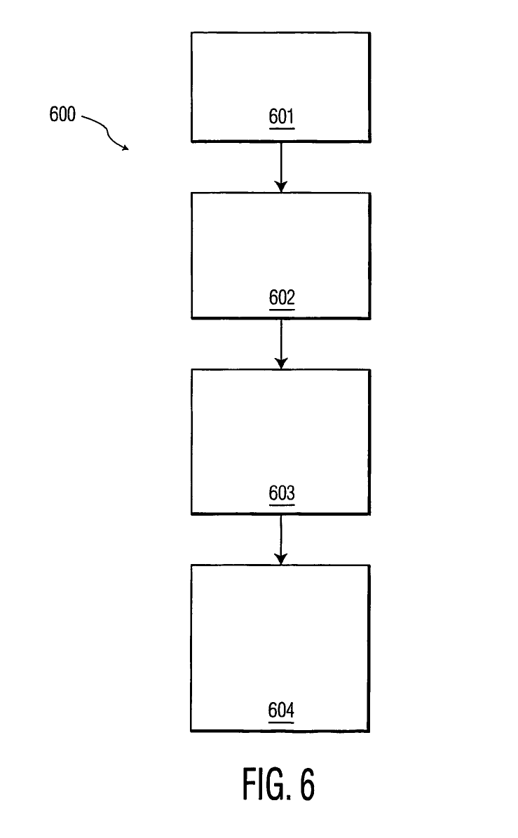

FIG. 6 is a flow chart illustrating the operation steps of receiving a request for a Medium Sensing Time Histogram Report, sensing the medium and generating a Medium Sensing Time Histogram Report, and storing it as an entry in a Medium Sensing Histogram Report table of a MIB Table and finally transmitting it over the medium; and

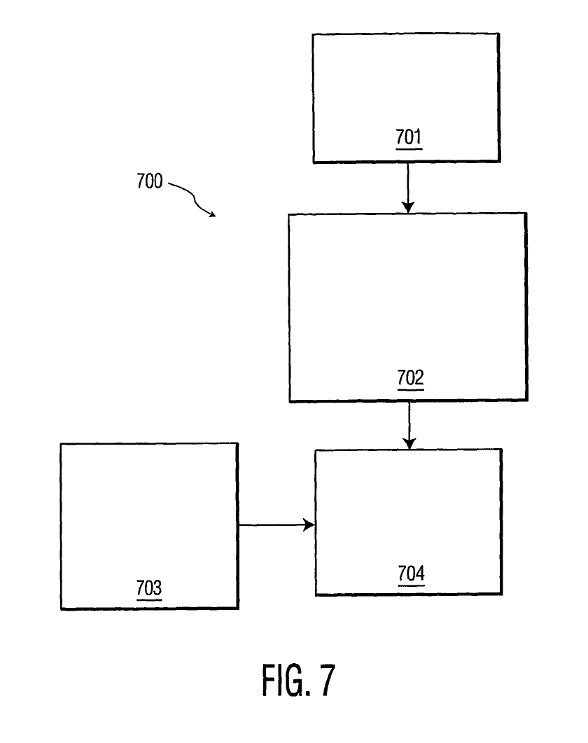

FIG. 7 is a flow chart illustrating the operation steps of requesting and receiving over the medium a Medium Sensing Time Histogram Report, sensing the medium locally and generating a local Medium Sensing Time Histogram Report, and storing the generated and received reports as an entry in a Medium Sensing Histogram Report table of a MIB Table.

It is to be understood by persons of ordinary skill in the art that the following descriptions are provided for purposes of illustration and not for limitation. An artisan understands that there are many variations that lie within the spirit of the in vention and the scope of the appended claims. Unnecessary detail of known functions and operations may be omitted from the current description so as not to obscure the present invention.

FIG. 3 illustrates a representative network environment whereto embodiments of the present invention are to be applied. As shown in FIG. 3, a wireless device 301 is communicates with a plurality of wireless devices 301 through a wireless link in which the wireless devices are communicated with each other via a plurality o f wireless channels. A key principle of the present invention is provide a mechanism to store, i.e., MIB Table, a sequence of at least one of a locally sensed and received from other wireless devices sequence of at least one Medium Sensing Time Histogram Report as at least one entry in a Medium Sensing Time Histogram Report Table defined by the present invention as a type of table that can be stored in a MIB Table.

Referring to FIG. 4, the wireless devices 301 within the WLAN of FIG. 3 may include a system with an architecture that is illustrated in the block diagram of FIG. 4. Each wireless device 301 may include a receiver 401, a processor 402, a time histogram management module 405, a memory 403 having a MIB Table 404, a timer 406 and a transmitter 407. The exemplary system 400 of FIG. 4 is for descriptive purposes only. Although the description may refer to terms commonly used in describing particular wireless devices, the description and concepts equally apply to other processing systems, including systems having architectures dissimilar to that shown in FIG. 3.

In operation, the receiver 401 and the transmitter 407 are coupled to an antenna (not shown) to receive and transmit time histogram reports, requests therefor, and to sense the medium for local generation of time histogram reports. The processor 402 controls the time histogram management module 405 in the storage and retrieval of each Medium Sensing Time Histogram Report Entry in a Medium Sensing Time Histogram Report Table of the MIB table 404 stored in the memory 404. The time histogram management module is also used to maintain the Medium Sensing Time Histogram Report Table as a first-in-first-out data table to preserve currency of the entries. Further, in a preferred embodiment Medium Sen sing Time Histogram Report Entries that have been received by the station management entity (SME) of the radio device are kept in the Medium Sensing Time Histogram Report Table for a predetermined minimum. In an implementation that is compliant with IEEE 802.11k standard this minimum retention time is dot 11 Measurement Report Aging Time after having been written in the MIB. After this predetermined amount of time since a report was written, the report entry can be erased by SME to free memory. The timer 406 is used to determine when an entry is outdated as well as to set the time of storage of an entry in MIB table.

FIG. 5 illustrates a Medium Sensing Time Histogram Report Entry in a Medium Sensing Time Histogram Table contained in a MIB Table according to the e present invention. An example of a software implementation of a Medium Sensing Time Histogram Report Table according to the present invention is contained in Appendix I. Each entry in the Medium Sensing Time Histogram Report Table according to the present invention comprises all the fields of the Medium Sensing Time Histogram Report illustrated in FIG. 2 and the additional fields: Index 501, Rqts Token 502, IfIndex 503, and STAAddr 504 and the Bin Densities 210 through 21(N−1) are stored in a Bin Table 505 indexed by Bin i Index 506i for I=0, . . . , N−1. A predetermined number of Medium Sensing Time Histogram Report entries can be stored in the MIB table. This predetermined number is ten.

A radio device, e.g., a STA, reports measurements using a Measurement Report element. The format of a Measurement Report field of each Medium Sensing Time Histogram Report entry is shown in FIG. 5. The subfields are defined as follows:
a. Each entry in the Table is indexed by Index.
b. The Request Token holds the request token that was specified in the measurement request that requested the measurement report corresponding to this entry and is an exact match to the original request token attribute.
c. The Interface Index is the interface index that the report corresponding to this entry was received on.
d. The STA Address is the MAC address of the measuring STA that made the measurements reported in the report corresponding to this entry.
e. The Channel Number indicates the channel number to which the Medium Sensing Time Histogram Report applies.
f. The Channel Band indicates the measured frequency band, taken from Table 2, in which the Channel Number applies.
g. The Measurement Duration shall be set equal to the duration over which the Medium Sensing Time Histogram Report was measured, expressed in TUs.

h. The Medium Sensing Measurement Subtype indicates the subtype of Medium Sensing Time Histogram Report, as defined in Table 6.

TABLE 6
Medium Sensing Measurement Subtype definition

| Medium Sensing | |
|---|---|
| Measurement Subtype | Medium Sensing Measurement Name |
| 0 | RPI Time Histogram |
| 1 | CCA Idle Time Histogram |
| 2 | CCA Busy Time Histogram |
| 3 | NAV Busy Time Histogram |
| 4-255 | Reserved |

i. The RPI Threshold identifies a received power level threshold according to Table 7, as seen at the antenna connector. The RPI Threshold is used to determine if a medium Sensing Event occurs, while collecting information for the RPI Time Histogram.

TABLE 7
RPI Threshold Definitions for an RPI Time Histogram

| RPI | Power Observed at Antenna (dBm) |
|---|---|
| 0 | −87 |
| 1 | −82 |
| 2 | −77 |
| 3 | −72 |
| 4 | −67 |
| 5 | −62 |
| 6 | −57 |
| 7-255 | reserved |

j. The Medium Sensing Time Histogram Report contains the densities in each of the N time intervals as measured in the specified channel over the measurement duration.
k. The Total Number of Medium Sensing Events 209 indicates how many events have been counted during the measurement. The Medium Sensing Events are defined in Table 8.
l. The Bin Tables stores indexed Bin i densities by storing N pairs comprising the Bin i index and the associated Bin i density. To compute the Bin i density, 0≦i<N, the measuring STA monitors the contiguous duration of the monitored state and increments count, Bᵢ, corresponding to Bin i. If a Medium Sensing Event occurs during the measurement at time t with
   i0+(i*Δi)<t ≦i0+((i+1)*Δi) for any i<N−1,
   i0+(i*Δi)≦t for i=N−1,

then the number of events per Bin i is increased by one. During the Medium Sensing Measurment, a histogram is generated that represents the probability distribution of Medium Sensing Events in time.

TABLE 8
Definition of Medium Sensing Event

| Medium Sensing | Medium Sensing Measurement | Medium Sensing Event for |
|---|---|---|
| Measurement Subtype | Name | Bin i |
| 0 | RPI Time Histogram | RPI changes from value higher |
| | | than threshold to value lower |
| | | than RPI threshold within the |
| | | interval (i0 + [i * Δi . . . (i + 1) * Δi]) |
| 1 | CCA Idle Time Histogram | CCA state changes from idle to |
| | | busy within the interval |
| | | (i0 + [i * Δi . . . (i + 1) * Δi]) |
| 2 | CCA Busy Time Histogram | CCA state changes from busy |
| | | to idle within the interval |
| | | (i0 + [i * Δi . . . (i + 1) * Δi]) |
| 3 | NAV Busy Time Histogram | NAV duration within the |
| | | interval (i0 + [i * Δi . . . (i + 1) * Δi]) |
| | | detected |
| 4-255 | reserved | reserved |

FIG. 6 illustrates a flow diagram 600 of the operation steps performed by a wireless device 301 receiving a Medium Sensing Time Histogram Measurement Request 601, sensing the medium and generating a local Medium Sensing Time Histogram Report 602, storing the report FIFO in a local MIB as a Medium Sensing Time Histogram Report entry while purging out-of-date entries in the MIB (if needed) 603, and transmitting over the medium the report with the device's address contained therein 604.

FIG. 7 illustrates a flow diagram 700 of the operation steps performed by a wireless device 301 requesting a Medium Sensing Time Histogram Measurement Report 701, sensing the medium and generating a local Medium Sensing Time Histogram Report with the local device's address contained therein 702, receiving over the medium a report with the measuring device's address contained therein 703, and storing the report(s) FIFO in a local MIB as a Medium Sensing Time Histogram Report entry while purging out-of-date entries in the MIB (if needed) 704.

While the preferred embodiments of the present invention have been illustrated and described, it will be understood by those skilled in the art that various changes and modifications may be made, and equivalents may be substituted for elements thereof without departing from the tru scope of the present invention. In addition, many modifications may be made to adapt to a particular situation and the teaching of the present invention without departing from its central scope. Therefore, it is intended that the present invention not be limited to the particular embodiments disclosed as the best mode contemplated for carrying out the present invention, but that the present invention include all embodiments falling within the scope of the appended claim

APPENDIX I
EXAMPLE IMPLEMENTATION OF MEDIUM SENSING
TIME HISTOGRAM REPORT TABLE

```
--
********************************************************************
-- * dot11MedSenseTimeHistogramReportTable
--
********************************************************************
dot11RRMMedSenseTimeHistogramReportMaxTableSize OBJECT-TYPE
      SYNTAX  Unsigned32(0..65535)
      MAX-ACCESS  read-only
      STATUS  current
      DESCRIPTION
                “Identifies the number of measurement reports
            that can be entered into
            MedSenseTimeHistogramReportTable.”
      ::= { dot11RRMReport <<#>> }
dot11MedSenseTimeHistogramReportTable OBJECT-TYPE
        SYNTAX SEQUENCE OF dot11MedSenseTimeHistogramReportEntry
        MAX-ACCESS not-accessible
        STATUS current
        DESCRIPTION
            “Group contains the current list of Medium Sensing Time
            Histogram report entries that have been received by the
            SME. The report tables shall be maintained as FIFO to
            preserve freshness, thus this attribute can be overridden
            by memory constraints or other implementation constraints
            determined by the vendor of this SME.”
    ::= { dot11smt <<#>> }
dot11MedSenseTimeHistogramReportEntry OBJECT-TYPE
        SYNTAX dot11MedSenseTimeHistogramReportEntry
        MAX-ACCESS not-accessible
        STATUS current
        DESCRIPTION
            “An entry in the dot11MedSenseTimeHistogramReportTable
            indexed by dot11MedSenseTimeHistogramReportIndex.”
        INDEX { dot11MedSenseTimeHistogramReportIndex }
    ::= { dot11MedSenseTimeHistogramReportTable 1 }
Dot11MedSenseTimeHistogramReportEntry ::=
        SEQUENCE {
            dot11MedSenseTimeHistogramReportIndex
            Unsigned32,
            dot11MedSenseTimeHistogramReportRqstToken
            OCTET STRING,
            dot11MedSenseTimeHistogramReportIfIndex
            InterfaceIndex,
            dot11MedSenseTimeHistogramMeasuringSTAAddr
            MacAddress,
            dot11MedSenseTimeHistogramReportChanNumber
            INTEGER,
            dot11MedSenseTimeHistogramReportChanBand
            INTEGER,
            dot11MedSenseTimeHistogramReportActualStartTime
            TSFType,
            dot11MedSenseTimeHistogramReportMeasurementDuration
            Unsigned32,
            dot11MedSenseTimeHistogramReportSubtype
            INTEGER,
            dot11MedSenseTimeHistogramReportRPIThreshold
            INTEGER,
            dot11MedSenseTimeHistogramReportBinOffset
            INTEGER,
            dot11MedSenseTimeHistogramReportBinInterval
            INTEGER,
            dot11MedSenseTimeHistogramReportNumBin
            INTEGER,
            dot11MedSenseTimeHistogramReportNumEvent
      INTEGER,
            dot11MedSenseTimeHistogramReportBinTable
            SEQUENCE OF dot11MedSenseTimeHistogramReportBinEntry
            }
dot11MedSenseTimeHistogramReportIndex OBJECT-TYPE
        SYNTAX Unsigned32
        MAX-ACCESS read-only
        STATUS current
        DESCRIPTION
            “Index for Medium Sensing Time Histogram Report table
            entries in dot11MedSenseTimeHistogramReportTable, greater
            than 0.”
    ::= { dot11MedSenseTimeHistogramReportEntry 1 }
dot11MedSenseTimeHistogramReportRqstToken OBJECT-TYPE
        SYNTAX OctetString
        MAX-ACCESS read-create
        STATUS current
        DESCRIPTION
            “ This attribute holds the request token that was
            specified in the measurement request that generated this
            measurement report. This should be an exact match to the
            original dot11RRMRqstToken attribute. ”
        DEFVAL { “ ”}
    ::= { dot11MedSenseTimeHistogramReportEntry 2 }
dot11MedSenseTimeHistogramReportIfIndex OBJECT-TYPE
        SYNTAX InterfaceIndex
        MAX-ACCESS read-only
        STATUS current
        DESCRIPTION
            “The InterfaceIndex for this row of Medium Sensing Time
            Histogram report has been received on.”
    ::= { dot11MedSenseTimeHistogramReportEntry 3 }
dot11MedSenseTimeHistogramMeasuringSTAAddr OBJECT-TYPE
        SYNTAX MacAddress
        MAX-ACCESS read-only
        STATUS current
        DESCRIPTION
            “The MAC address of the measuring STA for this row of
            Medium Sensing Time Histogram report.”
    ::= { dot11MedSenseTimeHistogramReportEntry 4 }
dot11MedSenseTimeHistogramReportChanNumber OBJECT-TYPE
        SYNTAX INTEGER
        MAX-ACCESS read-only
        STATUS current
        DESCRIPTION
            “The channel number on which this row of report has been
            detected.”
    ::= { dot11MedSenseTimeHistogramReportEntry 5 }
dot11MedSenseTimeHistogramReportChanBand OBJECT-TYPE
        SYNTAX INTEGER(0..1)
        MAX-ACCESS read-only
        STATUS current
        DESCRIPTION
            “Channel Band indicates the frequency band, taken from
            Table 0-2, TGk Spec, in which this row of beacon report
            has been conducted.
            0 : 2.4 GHz
            1 : 5 GHz
            Other values are reserved.”
    ::= { dot11MedSenseTimeHistogramReportEntry 6 }
dot11MedSenseTimeHistogramReportActualStartTime OBJECT-TYPE
        SYNTAX TSFType
        MAX-ACCESS read-only
        STATUS current
        DESCRIPTION
            “This attribute corresponds to the TSF value at the time
            when the measurement started.”
    ::= { dot11MedSenseTimeHistogramReportEntry 7 }
dot11MedSenseTimeHistogramReportMeasurementDuration OBJECT-TYPE
        SYNTAX Unsigned32
        MAX-ACCESS read-only
        STATUS current
        DESCRIPTION
            “This attribute corresponds to the duration over which
            the Medium Sensing Time Historgram Report was measured,
            expressed in TUs.”
    ::= { dot11MedSenseTimeHistogramReportEntry 8 }
dot11MedSenseTimeHistogramReportSubtype OBJECT-TYPE
        SYNTAX INTEGER(0..3)
        MAX-ACCESS read-only
        STATUS current
        DESCRIPTION
            “This attribute corresponds to the Measurement SubType
            for this row of MedSenseTimeHistogramReport. SubType is
            defined as:
            0: RPI Time Histogram
            1: CCA Idle Time Histogram
            2: CCA Busy Time Histogram
            3: NAV Busy Time Histogram
            other values are reserved.”
    ::= { dot11MedSenseTimeHistogramReportEntry 9 }
dot11MedSenseTimeHistogramReportRPIThreshold OBJECT-TYPE
        SYNTAX INTEGER(0..7)
        MAX-ACCESS read-only
        STATUS current
        DESCRIPTION
            “This attribute indicates the RPI threshold that was used
            for generating this row of MedSenseTimeHistogramReport.
            0: −87dBm observed at antenna
            1: −82dBm observed at antenna
            2: −77dBm observed at antenna
            3: −72dBm observed at antenna
            4: −67dBm observed at antenna
            5: −62dBm observed at antenna
            6: −57dBm observed at antenna
            other values are reserved.”
    ::= { dot11MedSenseTimeHistogramReportEntry 10 }
dot11MedSenseTimeHistogramReportBinOffset OBJECT-TYPE
        SYNTAX INTEGER
        MAX-ACCESS read-only
        STATUS current
        DESCRIPTION
            “This attribute indicates the bin offset in
            microseconds.”
    ::= { dot11MedSenseTimeHistogramReportEntry 11 }
dot11MedSenseTimeHistogramReportBinInterval OBJECT-TYPE
        SYNTAX INTEGER
        MAX-ACCESS read-only
        STATUS current
        DESCRIPTION
            “This attribute indicates the bin interval duration in
            multiples of aSlotTime.”
    ::= { dot11MedSenseTimeHistogramReportEntry 12 }
dot11MedSenseTimeHistogramReportNumBin OBJECT-TYPE
        SYNTAX INTEGER
        MAX-ACCESS read-only
        STATUS current
        DESCRIPTION
            “This attribute indicates the number of bins.”
    ::= { dot11MedSenseTimeHistogramReportEntry 13 }
dot11MedSenseTimeHistogramReportNumEvent OBJECT-TYPE
        SYNTAX INTEGER
        MAX-ACCESS read-only
        STATUS current
        DESCRIPTION
            “This attribute indicates the number of medium sensing
            events. The purpose of this value is to allow the
            calculation of absolute times, as well as providing a
            confidence indicator.”
    ::= { dot11MedSenseTimeHistogramReportEntry 14 }
dot11MedSenseTimeHistogramReportBinTable OBJECT-TYPE
        SYNTAX SEQUENCE OF dot11MedSenseTimeHistogramReportBinEntry
        MAX-ACCESS not-accessible
        STATUS current
        DESCRIPTION
            “Group contains the list of bin entries that are part of
            this time histogram.”
    ::= { dot11MedSenseTimeHistogramReportEntry 15 }
dot11MedSenseTimeHistogramReportBinEntry OBJECT-TYPE
        SYNTAX dot11MedSenseTimeHistogramReportBinEntry
        MAX-ACCESS not-accessible
        STATUS current
        DESCRIPTION
            “ An entry in the
dot11MedSenseTimeHistogramReportBinTable
indexed by dot11MedSenseTimeHistogramReportBinIndex.”
        INDEX { dot11MedSenseTimeHistogramReportBinIndex }
    ::= { dot11MedSenseTimeHistogramReportBinTable 1 }
Dot11MedSenseTimeHistogramReportBinEntry ::=
        SEQUENCE {
            dot11MedSenseTimeHistogramReportBinIndex  Unsigned32,
            dot11MedSenseTimeHistogramReportBinDensity  INTEGER
            }
dot11MedSenseTimeHistogramReportBinIndex OBJECT-TYPE
        SYNTAX Unsigned32
        MAX-ACCESS read-only
        STATUS current
        DESCRIPTION
            “ Index for Medium Sensing Time Histogram Report Bin
            Table entries in
            dot11MedSenseTimeHistogramReportBinTable, greater than
            0.”
    ::= { dot11MedSenseTimeHistogramReportBinEntry 1 }
dot11MedSenseTimeHistogramReportBinDensity OBJECT-TYPE
        SYNTAX INTEGER (0..255)
        MAX-ACCESS read-only
        STATUS current
        DESCRIPTION
            “This attribute indicates the probability of medium
            sensing events during the bin interval.”
    ::= { dot11MedSenseTimeHistogramReportBinEntry 2 }
```

We claim:

1. A method for storing and accessing at least one medium sensing time histogram measurement report (200) by a plurality of wireless network devices (301), comprising the steps of:
in a device of said plurality,
providing a table (404) having at least one entry (500) for storage of and access to at least one medium sensing time histogram measurement report (200);
obtaining at least one medium sensing time histogram measurement report (200);
storing the obtained at least one medium sensing time histogram measurement report as said at least one entry (500) in the provided table (404); and
identifying the source (504) of the medium sensing time histogram measurement.

2. The method of claim 1, wherein said obtaining step further comprises at least one of the steps of:
receiving (703) the medium sensing time histogram measurement report from another device of said plurality of devices; and
generating the medium sensing time histogram measurement report by the device (602) (702).

3. The method of claim 2, wherein said receiving step further comprises the step of first requesting (701) the medium sensing time histogram measurement report from another device of said plurality of devices.

4. The method of claim 2, wherein said generating step further comprises the steps of:
including in the medium sensing time histogram measurement report (200) at least one bin (210) comprising a count of occurrences of a predetermined type of medium event, each bin (210) corresponding to a predetermined time interval;
first sensing the medium for at least one said predetermined time interval;
while performing the sensing step, counting a number of occurrences of at least one predetermined type of medium sensing event (104); and
entering the count into the at least one bin (210) of the medium sensing time histogram measurement corresponding to the predetermined type and predetermined time interval.

5. The method of claim 4, wherein said sensing step further comprises performing said sensing step for a predetermined frequency channel band (102) of a predetermined frequency channel (101) for the predetermined type.

6. The method of claim 5, wherein said storing step further comprises the step of purging said at least one entry (500) according to a predetermined time-dependent rule.

7. The method of claim 6, wherein said storing step further comprises the step of storing said at least one measurement in a fist-in-first-out order (603) (704) in said provided table (404).

8. The method of claim 7, wherein:
said provided table (404) is a medium sensing time histogram report table contained in a management information base table located in each said wireless network device (301) of said plurality; and
each said device of said plurality of devices is an IEEE 802.11 wireless network device.

9. The method of claim 8, wherein each said at least one bin (210) further comprises a bin index (506) of the position of the bin (210) in the sequence of bins.

10. The method of claim 1, wherein said storing step further comprises the step of purging said at least one entry according to a predetermined time-dependent rule.

11. The method of claim 10, wherein said storing step further comprises the step of storing said at least one measurement in a first-in-first-out order (603) (704) in said provided table.

12. The method of claim 1, wherein:
said provided table is a medium sensing time histogram report table contained in a management information base table located in each said wireless network device (301) of said plurality; and
each said device (301) of said plurality of devices is an IEEE 802.11 wireless network device.

13. An apparatus (400) for storing and accessing a medium sensing time histogram report by a wireless network device (301), comprising:
a receiver (401) that receives at least one of a medium sensed input and a medium sensing time histogram measurement report (200);
a transmitter (407) that transmits a medium sensing time histogram measurement request (100);
a memory (403) including a table (404) having at least one entry for storage of at least one medium sensing time histogram report (200);
a processor (402) coupled to the receiver (401) to generate at least one medium sensing time histogram report entry (500) from the at least one medium sensed input and the received medium sensing time histogram measurement report (200); and
a time histogram management module (405) coupled to the processor (402) to receive and deliver a medium sensing time histogram report entry (500) and respectively manage storage thereof as said at least one entry and access thereto as said at least one entry in the table (403) of the memory (404).

14. The apparatus of claim 13, further comprising a timer (406) coupled to the processor (402) for the processor (402) to direct the time histogram management module (405) to purge said at least one entry according to a predetermined time-dependent rule; and wherein said time histogram management module (405) is further configured to purge said at least one entry under the control of the processor (405).

15. The apparatus of claim 14, wherein said time histogram management module (405) is further configured to store said at least one entry in a first-in-first-out order (603) (704) in said table (404) of said memory (403).

16. The apparatus of claim 15, wherein:
said table (404) is a medium sensing time histogram report table contained in a management information base table; and
said wireless network device is an EEE 802.11 wireless network device.

17. The apparatus of claim 13, wherein:
the receiver (401) is further configured to receive a request (100) for a medium sensing time histogram measurement report (200); and
the transmitter (407) is further configured to transmit a medium sensing time histogram measurement report (401) in response to a received medium sensing time histogram measurement request (100).

18. The apparatus of claim 17, wherein said time histogram management module (405) is further configured to purge said at least one entry according to a predetermined rule.

19. The apparatus of claim 18, wherein said time histogram management module is further configured to store said at least one entry in a first-in-first-out order (603) (704) in said table (404) of said memory (403).

20. The apparatus of claim 19, wherein said at least one entry (500) further comprises a bin table (505) having at least one bin (210) containing a count of occurrences of a predetermined type of medium event, said at least one bin (210) corresponding to a predetermined time interval.

21. The apparatus of claim 20, wherein each said at least one bin (210) further comprises a bin index (506) of the position of the bin (210) in the sequence of bins.

22. The apparatus of claim 21, wherein:
said table is a medium sensing time histogram report table contained in a management information base table; and
said wireless network device is an IEEE 802.11 wireless network device.
